(19) United States
(12) Patent Application Publication
(10) Pub. No.: US 2021/0035123 A1
(43) Pub. Date: Feb. 4, 2021

(54) Using Location Data and Mobile Application Data to Assess Product Competition

(71) Applicants: AT&T Intellectual Property I, L.P., Atlanta, GA (US); AT&T Mobility II LLC, Atlanta, GA (US)

(72) Inventors: Sheldon Kent Meredith, Roswell, GA (US); Zachary Meredith, Roswell, GA (US); Yevgeniy Puzyrev, Cumming, GA (US)

(73) Assignees: AT&T Intellectual Property I, L.P., Atlanta, GA (US); AT&T Mobility II LLC, Atlanta, GA (US)

(21) Appl. No.: 16/529,209

(22) Filed: Aug. 1, 2019

(51) Int. Cl. G06Q 30/02; G06Q 20/20; H04L 29/08; G06F 21/62

(52) U.S. Cl. CPC G06Q 30/0201; G06F 21/6254; H04L 67/22; G06Q 20/202

(57) ABSTRACT

Concepts and technologies disclosed herein are directed to using location data and mobile application data to assess product competition. According to one aspect disclosed herein, a product competition assessment system can obtain temporal location data for a user device associated with a customer. The temporal location data can identify a local store and a time period in which the customer was located at the local store. The system can obtain device usage data corresponding to the customer using the user device during the time period. The system can obtain point-of-sale (“POS”) data from a POS system associated with the local store. The POS data can include a purchase history associated with the customer during the time period. The system also can determine whether the purchase history identifies one or more items also identified in the device usage data.

### BACKGROUND

Physical stores have experienced increased pressure from online retailers over the last several years due, in part, to the ease and convenience of online shopping. Many people use their devices, such as smartphones, as an aid for researching, comparing, and purchasing products online as well as in physical stores. In fact, some reports indicate that up to 84% of smartphone shoppers utilize their smartphones while in a physical store to, among other things, research product specifications, compare prices, and read reviews.

Often times, people visit a physical store only to experience a product and then purchase the same product online, relegating the store to a mere product showcase for their online competitors. The upside for the customer may be a lower price online and no sales tax, where applicable. The downside is the wait time to receive the product and perhaps the shipping costs, although many online stores build-in the cost of shipping into their pricing to offer free shipping or charge a fee to allow the customer access to enhanced shipping options, including “free” and faster shipping options. The physical store cannot always know about prices, delivery times, shipping costs, and taxes for every potential online competitor. Customers, however, may learn about these aspects of a given product very quickly, often through the use of a smartphone with a web browser and/or dedicated online store application. Based on their research, customers will visit a store and choose a product, but then inspect Internet pricing as well as taxes, shipping, and time for delivery and make a decision whether or not to purchase the product in the store or order the product online.

### SUMMARY

Concepts and technologies disclosed herein are directed to aspects of using location data and mobile application data to assess product competition. According to one aspect disclosed herein, a product competition assessment system can obtain temporal location data for a user device associated with a customer. The temporal location data can identify a local store and a time period in which the customer was located at the local store. The system can obtain device usage data corresponding to the customer using the user device during the time period. The system can obtain point-of-sale (“POS”) data from a POS system associated with the local store. The POS data can include a purchase history associated with the customer during the time period. The system also can determine whether the purchase history identifies one or more items also identified in the device usage data.

In some embodiments, the system can determine that the purchase history does not identify the item also identified in the device usage data. In response, the system can notify the local store that the item was not purchased at the local store.

In some embodiments, the system can obtain the device usage data from an application executing on the user device. The application can be a software application installed on the user device dedicated to collecting the device usage data based upon the customer's interactions with the user device. The application can be a firmware of the user device. The application can be an operating system of the user device.

In some embodiments, the device usage data and the POS data are encrypted to obfuscate personally identifiable information associated with the customer. In these embodiments, the system can decrypt the device usage data and the POS data to match the customer to the purchase history without exposing the personally identifiable information associated with the customer.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating an operating environment in which the concepts and technologies disclosed herein can be implemented, according to an illustrative embodiment.

FIG. 2 is a flow diagram illustrating aspects of a method for determining a non-purchase event and notifying a local store of the non-purchase event, according to an illustrative embodiment.

FIG. 3 is a flow diagram illustrating aspects of a method for collecting device usage data while a user device is located within the local store and providing the device usage data to a product competition assessment system for assessment, according to an illustrative embodiment.

FIG. 4 is a flow diagram illustrating aspects of a method for generating point-of-sale data and providing the point-of-sale data to the product competition assessment system for assessment, according to an illustrative embodiment.

FIG. 5 is a block diagram illustrating an example mobile device, according to some illustrative embodiments.

FIG. 6 is a block diagram illustrating an example computer system, according to some illustrative embodiments.

FIG. 7 schematically illustrates a network, according to an illustrative embodiment.

FIG. 8 is a block diagram illustrating an example cloud computing platform capable of implementing aspects of the embodiments presented herein.

### DETAILED DESCRIPTION

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

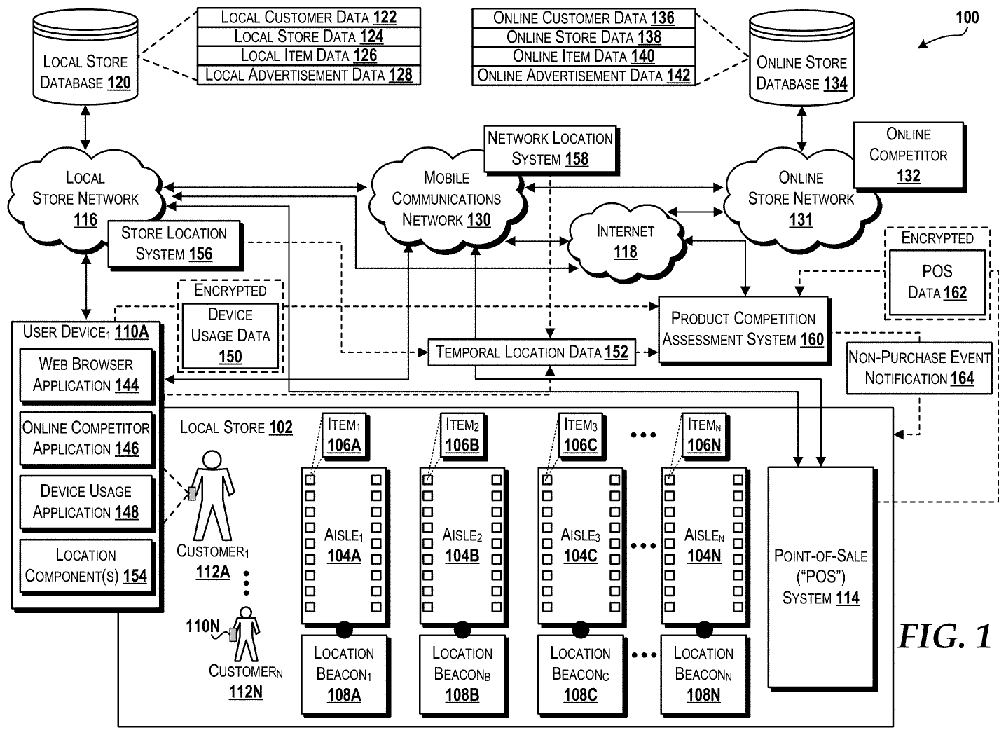

Referring now to FIG. 1, aspects of an operating environment 100 for various embodiments of the concepts and technologies disclosed herein will be described. The operating environment 100 includes a local store 102 that includes a plurality of aisles 104A-104N (hereinafter referred to individually as “an aisle 104”, or collectively as “aisles 104”) in which a plurality of items 106A-106N (hereinafter referred to individually as “an item 106”, or collectively as “items 106”) are located. The arrangement of the items 106 in the aisles 104 is provided as an exemplary example and should not be construed as being limiting in any way. Each of the plurality of aisles 104A-104N is associated with a corresponding one of a plurality of location beacons 108A-108N (hereinafter referred to individually as “a location beacon 108”, or collectively as “location beacons 108”). The plurality of location beacons 108A-108N can be utilized by one or more user devices 110A-110N (hereinafter referred to individually as “a user device 110”, or collectively as “user devices 110”) associated with one or more customers 112A-112N (hereinafter referred to individually as “a customer or user 112”, or collectively as “customers or users 112”) to determine a location of one or more of the user devices 110, and thus one or more of the customers 112, within the local store 102.

By way of example, the local store 102 may be a home improvement store or a grocery store. These examples are provided merely to aid in describing the concepts and technologies disclosed herein. It should be understood that the local store 102 alternatively may include any environment in which the items 106 may be offered for sale to the customers 112. Some example environments include, but are not limited to, outdoor environments, stadiums, tents and other temporary structures, houses and other residential environments, parking garages, commercial buildings, outdoor sales events, festivals, concerts, other non-retail environments, and the like.

Although the location beacons 108 are shown positioned at each of the aisles 104, the location beacons 108 alternatively or additionally may be positioned: within the aisles 104, such as to locate a specific one of the items 106 or type of the items 106; at an entrance and/or exit of the local store 102, such as to locate the user device 110, and thus the customer 112, entering or exiting the local store 102; at a parking lot or other area surrounding the local store 102, such as to locate the user device 110, and thus the customer 112, arriving at or departing from the local store 102 (e.g., in a vehicle); or otherwise providing a location of varying granularity to locate the user device 110, and thus the customer 112, at the local store 102, within the local store 102, or within a region served by the location beacon 108. The location beacons 108 can utilize any wireless technology, such as BLUETOOTH, BLUETOOTH LOW ENERGY (“BLE”), radio frequency identification (“RFID”), WI-FI, infrared, infrared data association (“IRDA”), near field communications (“NFC”), other RF technologies, combinations thereof, and the like. In some embodiments, the location beacons 108 are IBEACONS, available from APPLE INC., although other standardized and proprietary beacon technologies are contemplated.

The user devices 110, in some embodiments, can be mobile devices, such as, for example, smartphones, tablet devices, personal digital assistants, laptop computers, or the like. The user devices 110, in some other embodiments, can be wearable devices, such as, for example, smart watches, smart glasses, smart jewelry, fitness accessories, or the like. The customer 112 may be associated with any number of user devices 110, such as a smartphone and a smart watch that can be in communication via a short-range communications technology (e.g., BLUETOOTH, BLE, or NFC).

The user devices 110 can communicate with other systems and/or devices associated with the local store 102, including, in the illustrated example, a point-of-sale (“POS”) system 114. The POS system 114 can be used by the local store 102 to process transactions, such as a purchase transaction of one or more of the items 106 made by the customers 112. In some embodiments, the POS system 114 includes one or more self-checkout kiosks, one or more automated checkout systems, and/or one or more attended checkout systems, each of which can include one or more devices for scanning (e.g., barcode scan; RFID scan; NFC scan) of the item(s) 106 the customer 112 wants to purchase, one or more devices for processing a transaction (e.g., a credit card reader, NFC payment reader, and/or the like), one or more devices for printing or otherwise disseminating (e.g., via email or text message) a receipt for the item(s) 106 purchased by the customer 112, and one or more devices for communicating with a local store network 116.

The local store network 116 can be or can include one or more wireless local area networks (“WLANs”), and may additionally include one or more wired LANs. In some embodiments, the local store network 116 includes one or more wireless access points (not shown) that operate in accordance with IEEE 802.11X specifications to provide the user device 110 with wireless connectivity to the local store network 116 through which the user device 110 can communicate with the Internet 118. The local store network 116 also provides connectivity for the POS system 114 to communicate with external networks, such as the Internet 118. The POS system 114 also can be in communication with the local store network 116 to perform operations described herein, such as to access a local store database 120.

The illustrated local store database 120 is shown with local customer data 122, local store data 124, local item data 126, and local advertisement data 128. The local store database 120 can include other data associated with any aspect of the local store 102. It is contemplated that the local store database 120 can store other data that does not fall into one or more of the aforementioned data categories. As such, the inclusion of the aforementioned data categories in the local store database 120 should not be construed as being limiting in any way.

The local customer data 122 can include data associated with one or more customers such as the illustrated customer 112. For example, the local customer data 122 can include identity data such as name, birth date, gender, one or more physical addresses, one or more telephone numbers, one or more email addresses, social network information, customer account information including account identifiers and/or user identifiers, and/or job information. The local customer data 122 can additionally or alternatively include quantitative data, such as, for example, transactional information such as the number of items 106 purchased, details regarding the item purchases, value of item purchased, and item return history; communication information such as communication date, communication channel (e.g., telephone, email, chat, or social network) and communication subject; online activity such as website visits, item views, online registration information, and social network activity including posts, likes, and other social network interactions; and customer service information such as customer complaint details and customer inquiry details. The local customer data 122 can additionally or alternatively include descriptive data, such as, for example, marital status, number of children, age of children, property type, car type, number of car doors, number and type of pets, annual income, profession, education level, and the like. The local customer data 122 can additionally or alternatively include qualitative data, such as, for example, attitudinal information regarding how customers rate customer service and the likelihood of purchasing the item(s) 106 again; opinion information regarding customer's favorite colors, favorite vacation locations, and other personal opinions; and emotional information regarding why the item(s) 106 was purchased (e.g., personal use, business use or as a gift), one or more reasons for purchasing a product (e.g., locality, brand, price, and/or quality), and the like. The local customer data 122 also can include permission and suppression preferences. It should be understood that the customer data 122 can include any combination of the aforementioned data and other data associated with customer that is not specified herein.

The local store data 124 can include data associated with various aspects of the local store 102. For example, the local store data 124 can include dimensions of the local store 102, a layout of the local store 102, the location of each of the aisles 104 and/or other areas (e.g., departments, restrooms, customer service, cashiers, and the like) within the local store 102, and the locations of the location beacons 108. It should be understood that the local store data 124 can include any combination of the aforementioned data and other data associated with the local store 102 that is not specified herein.

The local item data 126 can include data associated with one or more of the items 106 available for purchase within the local store 102. The local item data 126 can include, for example, category, title, description, image, uniform resource locator (“URL”) for a corresponding web page on a website associated with the local store 102, stock keeping unit (“SKU”), universal product code (“UPC”), shelf-life, wholesale price, retail price, sales price, historical price/price trend(s), location within the local store 102, quantity-on-hand, quantity-on-order, and backorder status. It should be understood that the local item data 126 can include any combination of the aforementioned data and other data associated with the items 106 that is not specified herein.

The local advertisement data 128 can include data associated with one or more advertisements about one or more of the items 106. The advertisement data 128 can include identifiers that map to one or more of the items 106 for which data is stored as part of the local item data 126 and for which one or more advertisements are available. The local advertisement data 128 can additionally include an advertisement category, advertisement title, advertisement graphics, advertisement audio, advertisement video, advertisement description, advertisement price, advertisement restrictions, advertisement start date, and/or advertisement expiration date. It should be understood that the local advertisement data 128 can include any combination of the aforementioned data and other data associated with one or more advertisements for one or more of the items 106.

The user devices 110, in the illustrated example, are operating in communication with and/or as part of a mobile communications network 130. The user devices 110 can communicate with the mobile communications network 130 using any wireless communications technology or combination of wireless communications technologies, some examples of which include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The user devices 110 can communicate with the mobile communications network 130 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the user devices 110 and the mobile communications network 130 via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the mobile communications network 130 may additionally include infrastructure that operates on wired communications technologies, including, but not limited to, optical fiber, coaxial cable, twisted pair cable, and the like to transfer data between various systems operating on or in communication with the mobile communications network 130. The mobile communications network 130 also can provide connectivity to the local store network 116, the Internet 118, and an online store network 131.

The online store network 131 can be associated with an online competitor 132 to the local store 102. The online competitor 132 may offer the items 106 and/or similar items at a different total price (i.e., the sum of item price, tax, shipping/handling, and other costs) from the local store 102. Although a single online competitor 132 is illustrated, the local store 102 may have multiple online competitors 132.

The online store network 131 is shown in communication with an online store database 134 that is shown with online customer data 136, online store data 138, online item data 140, and online advertisement data 142, which can include data such as described above with respect to the local customer data 122, the local store data 124, the local item data 126, and the local advertisement data 128, respectively, but for the online competitor 132. The online store database 134 can store other data associated with any aspect of the online competitor 132.

While the customer 112 is shopping in the local store 102, he or she may utilize the user device 110 to access the online store network 131 to research one or more of the items 106, compare pricing of the items 106 to the same or similar items 106 offered by the online competitor 132, and otherwise learn more information about the item(s) 106. For example, the customer 112 may use a web browser application 144 to access a web site, a web application, or other web-based content associated with the online competitor 132 via one or more uniform resource locators (“URLs”) to access information about the items 106 and/or similar items offered for sale by the online competitor 132. A URL may include a reference to a specific item, such as a name, product identifier, SKU, and/or any other information that can be used to identify the specific item. Some online competitors 132 might use URLs that are shortened for ease of manual entry, or other forms of URLs that do not clearly identify specific item associated therewith. The hypertext markup language (“HTML”) code and/or other web code may provide further insight that is helpful to identify the specific item. For example, the naming convention used to name certain web elements like pictures may include the name of the item that is not clearly identified in the URL. The customer 112 also may use an online competitor application 146 for similar purposes. The online competitor application 146 may be a standalone application that can be installed on the user device 110 for the customer 112 to interact with the online competitor 132 in various ways, including to research one or more of the items 106, to compare pricing of the items 106 to the same or similar items 106 offered by the online competitor 132, and to otherwise learn more information about the item(s) 106, as well as access application specific content that is better-suited for an application environment than a browser-based environment. In any case, the online competitor 132 may provide the same or different experiences via a website and the online competitor application 146. Moreover, the content also may be the same or different.

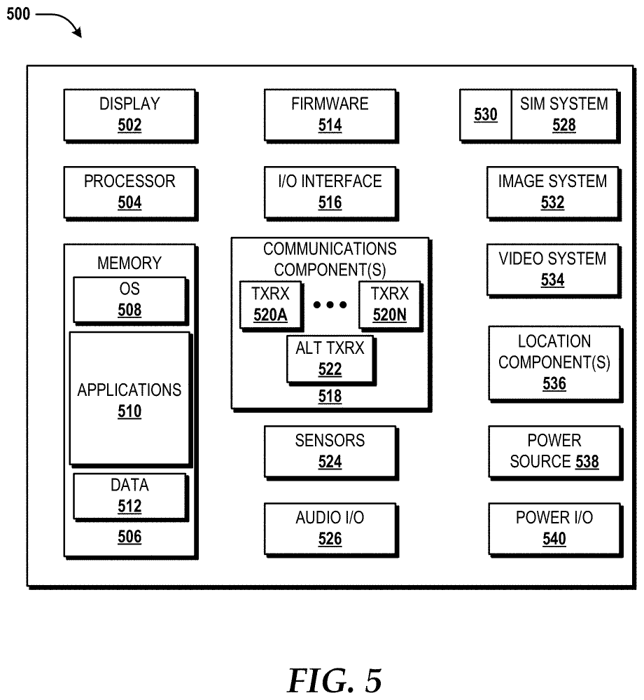

A device usage application 148 can be executed by the user device 110 to collect device usage data 150 corresponding to the customer 112 using the user device 110 during the time period in which the customer 112 is located at the local store 102. The device usage application 148 can be a standalone application installed on the user device 110. Alternatively, the device usage application 148 can be built-in to an operating system or a firmware (both best shown in FIG. 5) of the user device 110.

In some embodiments, the device usage application 148 runs continuously in the background as the user device 110 is used by the customer 112 to collect the device usage data 150 indicative of how the user device 110 is used. In other embodiments, the device usage application 148 can be triggered to begin collecting the device usage data 150 in response to the user device 110 being in or near a certain location at a certain time that is represented by temporal location data 152. The device usage data 150 can include any data associated with an interaction between the customer 112 and the user device 110 to access data provided by the online competitor 132 with regard to one or more of the items 106. For example, input provided by the customer 112, such as keyboard input, voice control input, camera input (e.g., a barcode scan), and/or input into certain fields or other aspects of another application (e.g., the web browser application 144 and/or the online competitor application 146), can be representative of the interaction between the customer 112 and the user device 110. Moreover, the output resulting from that input also can be representative of the interaction between the customer 112 and the user device 110. In one non-limiting example, the customer 112 might enter a URL for a website associated with the online competitor 132, followed by subsequent input to navigate the website to find a particular one or more of the items 106 also available from the local store 102. These inputs can be collected by the device usage application 148 and represented in the device usage data 150.

The temporal location data 152 may be obtained by one or more or more location components 154 of the user device 110, from a store location system 156, and/or from a network location system 158. In some embodiments, the location component(s) 154 of the user device 110 can include a global positioning system (“GPS”) component. In some other embodiments, the location component(s) 154 of the user device 110 can include a short-range communications component that can communicate with one or more of the location beacons 108 to determine the location of the user device 110 within the local store 102. In these embodiments, the short-range communications component can utilize BLUETOOTH, BLE, infrared, IRDA, NFC, other RF technologies, other light-based technologies, combinations thereof, and the like to communicate with one or more of the location beacons 108 to determine the location of the user device 110 within the local store 102. Other technologies, including quick response codes, barcodes, three-dimensional barcodes, and the like may be used by the user device 110 to establish location within the local store 102.

The store location system 156 can communicate with one or more of the location beacons 108 to determine the temporal location data 152. The store location system 156 alternatively or additionally can rely on network information from the local store network 116 to determine the temporal location data 152 via triangulation of one or more network access points (not shown) of the local store network 116. Other indoor location determining techniques may be utilized to determine the location of the user device 110 within the local store 102.

The mobile communications network 130 can be in communication with or can include the network location system 158. The network location system 158 can determine the temporal location data 152 by leveraging one or more network-based location determining techniques, such as, but not limited to, cellular triangulation, WI-FI triangulation, cell ID, forward link timing, or some combination thereof.

A product competition assessment system 160 is illustrated as being in communication with the Internet 118 through which the product competition assessment system 160 can communicate with the user device 110, the POS system 114, the mobile communications network 130, the store location system 156, and the network location system 158. The product competition assessment system 160 can be provided by a third party who is not associated with the mobile communications network 130 and the local store 102. Alternatively, the product competition assessment system 160 is provided by a mobile operator associated with the mobile communications network 130.

The product competition assessment system 160 can obtain the temporal location data 152 from the user device 110, the store location system 156, and/or the network location system 158. It should be understood that the temporal location data 152 does not need to be sent to the product competition assessment system 160 while the user device 110 is located within the local store 102 since the temporal location data 152 can include the specific time or time period in which the user device 110 was located within the local store 102. Moreover, the temporal location data 152 can be sent in batches that include a time and location associated with multiple customers 112. As such, the example provided herein of the temporal location data 152 being associated with a single customer 112 associated with a single user device 110 should not be construed as limiting in any away.

The product competition assessment system 160 can obtain the device usage data 150 from the device usage application 148 executed by the user device 110. In some embodiments, the device usage data 150 can be encrypted by the user device 110 to obfuscate personally identifiable information associated with the customer 112. The product competition assessment system 160 alternatively or additionally can obtain the device usage data 150 (including encrypted versions) from a mobile operator that provides, at least in part, the mobile communications network 130. Combinations of data from the mobile operator and the user device 110 can constitute the device usage data 150.

The product competition assessment system 160 can obtain POS data 162 from the POS system 114. The POS data 162 can include all transaction data associated with transactions conducted by the POS system 114, or specific transaction data such as transaction data associated with a purchase history of the customer 112 during the time period in which the customer 112 was located at the local store 102. In some instances, the purchase history can include a null value to indicate that no purchase was made by the customer 112. The POS system 114 may be prompted to provide the POS data 162 to the product competition assessment system 160 in accordance with a schedule (e.g., hourly, daily, monthly, yearly, etc.), upon request made by the product competition assessment system 160, or responsive to a trigger such as receiving notification from the store location system 156 that the user device 110 is no longer within the local store 102.

The POS data 162, like the device usage data 150, can be encrypted. In some embodiments, the POS system 114 encrypts the POS data 162 using the same encryption key shared with the device usage application 148 or the mobile operator depending upon where the device usage data 150 is encrypted. In this manner, any personally identifiable information contained in the device usage data 150 and/or the POS data 162 is not shared among the mobile operator and the local store 102. The product competition assessment system 160, operating as a third party, can receive the encrypted device usage data 150 and the encrypted POS data 162, decrypt this data, and match the data to the customer 112 to determine whether the customer 112 purchased a specific one or more of the items 106 while the customer 112 was in the local store 102 and accessed, via the user device 110, the online competitor 132 to research, compare prices, or otherwise inquire about the item(s) 106 also available, from the online competitor 132. In other words, the product competition assessment system 160 can determine whether the purchase history of the customer 112 as identified in the POS data 162 identifies the item(s) 106 also identified in the device usage data 150.

The product competition assessment system 160 can notify the local store 102 of whether or not the customer 112 purchased the item(s) 106. In the case that the customer 112 did not purchase the item(s) 106 when the customer 112 also conducted at least some interaction with the online competitor 132 as indicated by the device usage data 150, the product competition assessment system 160 can provide a non-purchase event notification 162 to the local store 102. The local store 102 can utilize the non-purchase event notification 162 to effect change to one or more aspects of the local store's 102 business. For example, the local store 102 might adjust the price on one or more of the items 106, may promote a local advertisement associated with one or more of the items 106, change the presentation of the item(s) 106 within the local store 102 (e.g., moving the item(s) 106 from within the aisle 104 to an end cap of the aisle 104), or otherwise make a change to be more competitive with the online competitor 132 at least with regard to the item(s) 106.

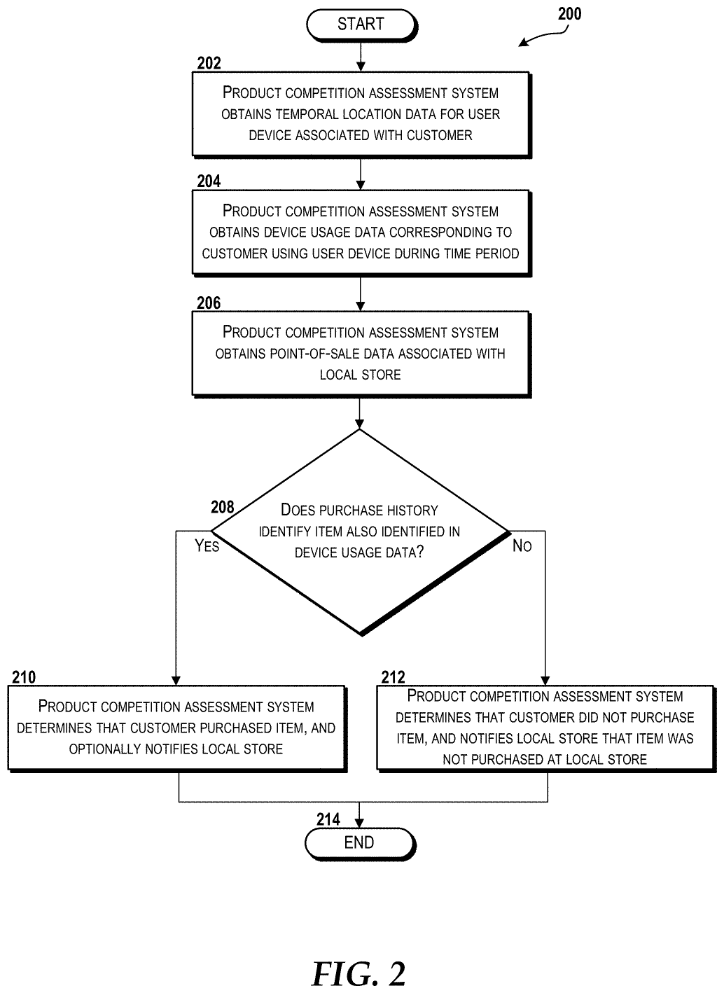

Turning now to FIG. 2, a method 200 for collecting the device usage data 150 while the user device 110 is located within the local store 102 and providing the device usage data 150 to the product competition assessment system 160 for assessment will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, for example, one or more of the user devices 110, the POS system 114, the product competition assessment system 160, the store location system 156, or the network location system 158 to perform one or more operations and/or causing the processor to direct other components of the computing system or device to perform one or more of the operations.

For purposes of illustrating and describing the concepts of the present disclosure, operations of the methods disclosed herein are described as being performed by one or more of the user devices 110, the POS system 114, the product competition assessment system 160, the store location system 156, or the network location system 158 alone or in combination via execution of one or more software modules such as, for example, the web browser application 144, the online competitor application 146, the device usage application 148, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described as being performed by the product competition assessment system 160. The method 200 begins and proceeds to operation 202, where the product competition assessment system 160 obtains the temporal location data 152 for the user device 110 associated with the customer 112. The product competition assessment system 160 can obtain the temporal location data 152 from the user device 110, the store location system 156, and/or the network location system 158.

From operation 202, the method 200 proceeds to operation 204, where the product competition assessment system 160 obtains the device usage data 150 corresponding to the customer's 112 use the user device 110 during the time period identified in the temporal location data 152. The product competition assessment system 160 can obtain the device usage data 150 from the device usage application 148 executed by the user device 110. Additionally or alternatively, the mobile operator that provides, at least in part, the mobile communications network 130 can provide the device usage data 150 to the product competition assessment system 160.

From operation 204, the method 200 proceeds to operation 206, where the product competition assessment system 160 obtains, from the POS system 114, the POS data 162 associated with the local store 102. The POS system 114 may be prompted to provide the POS data 162 to the product competition assessment system 160 in accordance with a schedule (e.g., hourly, daily, monthly, yearly, etc.), upon request made by the product competition assessment system 160, or responsive to a trigger such as receiving notification from the store location system 156 that the user device 110 is no longer within the local store 102.

From operation 206, the method 200 proceeds to operation 208, where the product competition assessment system 160 determines whether the purchase history obtained from the POS data 162 identifies one or more of the items 106 also identified in the device usage data 150. If the purchase history identifies the item(s) 106 also identified in the device usage data 150, the method 200 proceeds to operation 210, where the product competition assessment system 160 determines that the customer 112 purchased the item(s) 106 while the customer 112 was in the local store 102. Optionally, at operation 210, the product competition assessment system 160 notifies the local store 102 that the customer 112 interacted, in some capacity, with the online competitor 132 with regard to the item(s) 106 while the customer 112 was in the local store 102. If, however, the purchase history does not identify the item(s) 106 also identified in the device usage data 150, the method 200 proceeds from operation 208 to operation 212, where the product competition assessment system 160 determines that the customer 112 did not purchase the item(s) 106 while the customer 112 was in the local store 102. Also at operation 212, the product competition assessment system 160 notifies the local store 102 that the customer 112 interacted, in some capacity, with the online competitor 132 with regard to the item(s) 106 while the customer 112 was in the local store 102 but did not purchase the item(s) 106 from the local store 102. This notification can be sent via the non-purchase event notification 162, for example.

From either operation 210 or operation 212, the method 200 proceeds to operation 214. The method 200 ends at operation 214. The method 200 is described above in context of one customer 112. It is contemplated that the operations 202-212 can be performed in consideration of multiple customers 112. In some embodiments, the product competition assessment system 160 can generate a report and/or provide other information about the performance of the local store 102 in being competitive with the online competitor 132 based upon an analysis of the device usage data 150 and the POS data 162 obtained by the product competition assessment system 160 over a specified time period. In this manner, the local store 102 can adjust the price on one or more of the items 106, promote a local advertisement associated with one or more of the items 106, change the presentation of the item(s) 106 within the local store 102 (e.g., moving the item(s) 106 from within the aisle 104 to an end cap of the aisle 104), or otherwise make a change to be more competitive with the online competitor 132 at least with regard to the item(s) 106.

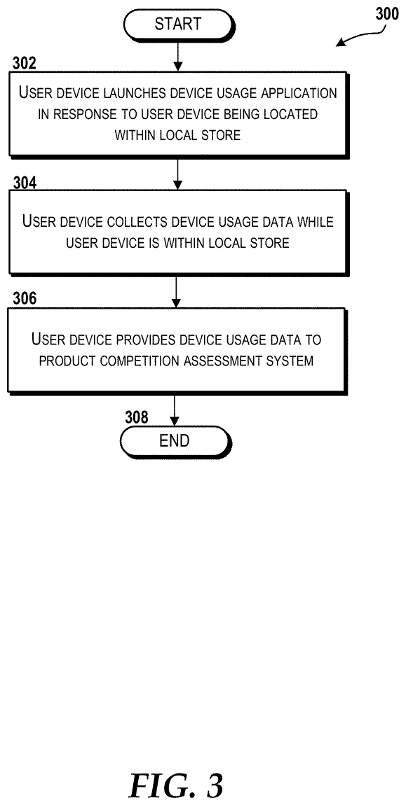

Turning now to FIG. 3, a method 300 for collecting the device usage data 150 while the user device 110 is located within the local store 102 and providing the device usage data 150 to the product competition assessment system 160 for assessment will be described, according to an illustrative embodiment. The method 300 begins and proceeds to operation 302, where the user device 110 launches the device usage application 148 in response to the user device 110 being located within the local store 102. Alternatively, as mentioned above, the user device 110 can execute the device usage application 148 to run continuously in the background.

From operation 302, the method 300 proceeds to operation 304, where the user device 110 collects the device usage data 150 while the user device 110 is within the local store 102. The device usage data 150 can include any data associated with an interaction between the customer 112 and the user device 110 to access data provided by the online competitor 132 with regard to one or more of the items 106. For example, input provided by the customer 112, such as keyboard input, voice control input, camera input, and/or input into certain fields or other aspects of another application (e.g., the web browser application 144 and/or the online competitor application 146), can be representative of the interaction between the customer 112 and the user device 110. Moreover, the output resulting from that input also can be representative of the interaction between the customer 112 and the user device 110. In one non-limiting example, the customer 112 might enter a URL for a website associated with the online competitor 132, followed by subsequent input to navigate the website to find a particular one or more of the items 106 also available from the local store 102. These inputs can be collected by the device usage application 148 and represented in the device usage data 150.

From operation 304, the method 300 proceeds to operation 306, where the user device 110 provides the device usage data 150 to the product competition assessment system 160. The product competition assessment system 160 can receive the device usage data 150 from the user device 110 and can proceed as described above with reference to the method 200 shown in FIG. 2.

From operation 306, the method 300 proceeds to operation 308. The method 300 ends at operation 308.

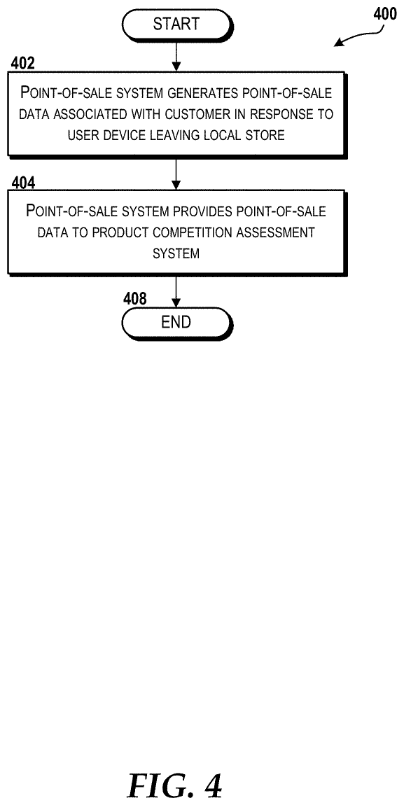

Turning now to FIG. 4, a method 400 for generating the POS data 162 and providing the POS data 162 to the product competition assessment system 160 for assessment will be described, according to an illustrative embodiment. The method 400 begins and proceeds to operation 402, where the POS system 114 generates the POS data 162 associated with the customer 112 in response to the user device 110 leaving the local store 102. The POS system 114 additionally or alternatively can generate the POS data 162 at other times such as described in the other examples presented herein.

From operation 402, the method 400 proceeds to operation 404, where the POS system 114 provides the POS data 162 to the product competition assessment system 160. The product competition assessment system 160 can receive the POS data 162 from the POS system 114 and can proceed as described above with reference to the method 200 shown in FIG. 2.

Turning now to FIG. 5, an illustrative mobile device 500 and components thereof will be described. In some embodiments, the user devices 110 described above, in part, with reference to FIG. 1 can be configured as and/or can have an architecture similar or identical to the mobile device 500 described herein with respect to FIG. 5. It should be understood, however, that the user devices 110 may or may not include the functionality described herein with reference to FIG. 5. While connections are not shown between the various components illustrated in FIG. 5, it should be understood that some, none, or all of the components illustrated in FIG. 5 can be configured to interact with one other to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. According to various embodiments, the display 502 can be configured to display various graphical user interface (“GUI”) elements, text, images, video, virtual keypads and/or keyboards, messaging data, notification messages, metadata, internet content, device status, time, date, calendar data, device preferences, map and location data, customer service interactions, combinations thereof, and the like. The mobile device 500 also can include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510 (e.g., the web browser application 144, the online competitor application 146, and the device usage application 148), other computer-executable instructions stored in a memory 506, or the like. In some embodiments, the applications 510 also can include a UI application (not illustrated in FIG. 5).

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in interacting with the mobile device 500. The UI application can be executed by the processor 504 to aid a user in answering/initiating calls, entering/deleting other data, entering and setting user IDs and passwords for device access, configuring settings, manipulating address book content and/or settings, multimode interaction, interacting with other applications 510, and otherwise facilitating user interaction with the operating system 508, the applications 510, and/or other types or instances of data 512 that can be stored at the mobile device 500.

According to various embodiments, the applications 510 can include, for example, the web browser application 144, the online competitor application 146, the device usage application 148, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 510, the data 512, and/or portions thereof can be stored in the memory 506 and/or in a firmware 514, and can be executed by the processor 504. The firmware 514 also can store code for execution during device power up and power down operations. It should be appreciated that the firmware 514 can be stored in a volatile or non-volatile data storage device including, but not limited to, the memory 506 and/or a portion thereof.

The mobile device 500 also can include an input/output (“I/O”) interface 516. The I/O interface 516 can be configured to support the input/output of data. In some embodiments, the I/O interface 516 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 also can include a communications component 518. The communications component 518 can be configured to interface with the processor 504 to facilitate wired and/or wireless communications with one or more networks, such as the local store network 116, the Internet 118, the mobile communications network 130, the online store network 131, and one or more of the location beacons 108. In some embodiments, the communications component 518 includes a multimode communications subsystem for facilitating communications via a cellular network and one or more other non-cellular networks (e.g., WI-FI).

The communications component 518, in some embodiments, includes one or more transceivers. The one or more transceivers, if included, can be configured to communicate over the same and/or different wireless technology standards with respect to one another. For example, in some embodiments one or more of the transceivers of the communications component 518 may be configured to communicate using GSM, CDMAONE, CDMA2000, LTE, and various other 2G, 2.5G, 3G, 4G, and greater generation technology standards. Moreover, the communications component 518 may facilitate communications over various channel access methods (which may or may not be used by the aforementioned standards) including, but not limited to, TDMA, FDMA, W-CDMA, OFDM, SDMA, and the like.

In addition, the communications component 518 may facilitate data communications using GPRS, EDGE, the HSPA protocol family including HSDPA, EUL or otherwise termed HSUPA, HSPA+, and various other current and future wireless data access standards. In the illustrated embodiment, the communications component 518 can include a first transceiver (“TxRx”) 520A that can operate in a first communications mode (e.g., GSM). The communications component 518 also can include an N^{th} transceiver (“TxRx”) 520N that can operate in a second communications mode relative to the first transceiver 520A (e.g., UMTS). While two transceivers 520A-N (hereinafter collectively and/or generically referred to as “transceivers 520”) are shown in FIG. 5, it should be appreciated that less than two, two, or more than two transceivers 520 can be included in the communications component 518.

The communications component 518 also can include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, BLE, infrared, IRDA, NFC, other RF technologies, combinations thereof, and the like. As such, the alternative transceiver 522 facilitates communications with one or more of the location beacons 108.

In some embodiments, the communications component 518 also can facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 also can include one or more sensors 524. The sensors 524 can include temperature sensors, light sensors, air quality sensors, movement sensors, orientation sensors, noise sensors, proximity sensors, or the like. As such, it should be understood that the sensors 524 can include, but are not limited to, accelerometers, magnetometers, gyroscopes, infrared sensors, noise sensors, microphones, combinations thereof, or the like. One or more of the sensors 524 can be used to detect movement of the mobile device 500. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices.

The illustrated mobile device 500 also can include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 also can include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content. Photos and videos obtained using the image system 532 and the video system 534, respectively, may be added as message content to a multimedia message service (“MMS”) message, email message, and sent to another mobile device. The video and/or photo content also can be shared with other devices via various types of data transfers via wired and/or wireless communication devices as described herein.

The mobile device 500 also can include one or more location components 536 (e.g., including the location component(s) 154 described above with reference to FIG. 1). The location components 536 can be configured to send and/or receive signals to determine a location of the mobile device 500. According to various embodiments, the location components 536 can send and/or receive signals from GPS devices, assisted-GPS (“A-GPS”) devices, WI-FI/WIMAX and/or cellular network triangulation data, combinations thereof, and the like. The location component 536 also can be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 also can include a power source 538. The power source 538 can include one or more batteries, power supplies, power cells, and/or other power subsystems including alternating current (“AC”) and/or direct current (“DC”) power devices. The power source 538 also can interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

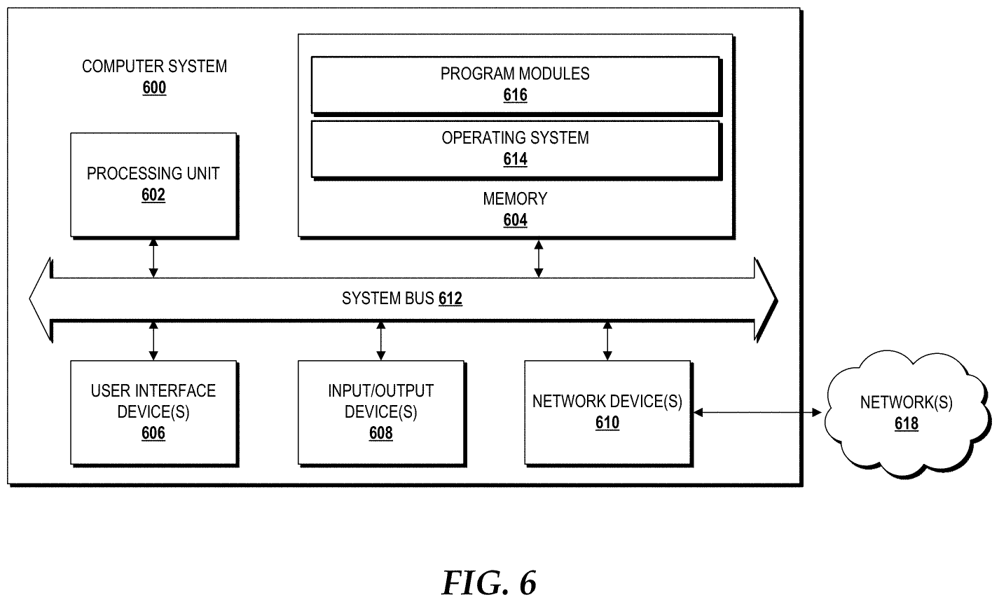

FIG. 6 is a block diagram illustrating a computer system 600 configured to provide the functionality described herein in accordance with various embodiments of the concepts and technologies disclosed herein. In some embodiments, the user devices 110, the POS system 114, the store location system 156, the product competition assessment system 160, the network location system 158, and/or other systems associated with the local store 102, the local store network 116, the Internet 118, the online store network 131, the local store database 120, the online store database 134, and/or other systems that can be implemented in accordance with the concepts and technologies disclosed herein, can be configured as and/or can have an architecture similar or identical to the computer system 600 described herein with respect to FIG. 6. It should be understood, however, that any of the aforementioned systems may or may not include the functionality described herein with reference to FIG. 6.

The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the computer system 600. Processing units are generally known, and therefore are not described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. According to embodiments, the program modules 616 may be embodied in hardware, software, firmware, or any combination thereof. Although not shown in FIG. 6, it should be understood that the memory 604 also can be configured to store all or a portion of the data contained in the local store database 120 or the online store database 134, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer to output data in the form of text, numbers, characters, maps, other visualizations, and the like.

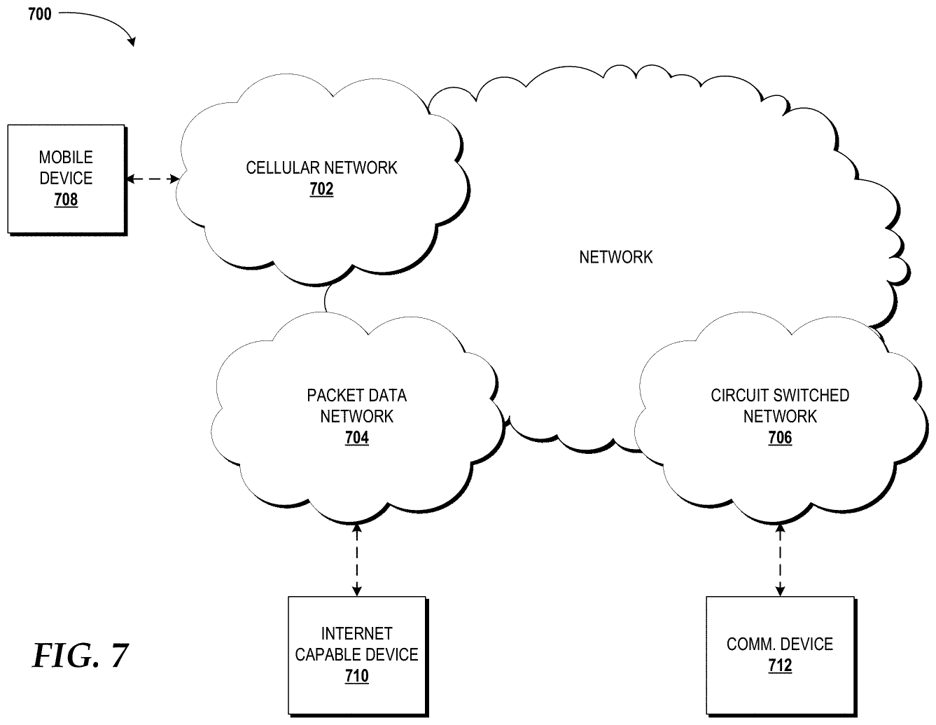

The network devices 610 enable the computer system 600 to communicate one or more networks such as the local store network 116, the mobile communications network 130, the Internet 118, the online store network 131, and/or other networks such as illustrated in FIG. 7. Examples of the network devices 610 include, but are not limited to, a modem, a RF or IR transceiver, a telephonic interface, a bridge, a router, or a network card. The network(s) may include a wireless network such as, but not limited to, a WLAN such as a WI-FI network, a wireless wide area network (“WWAN”), a wireless personal area network (“WPAN”) such as BLUETOOTH, a wireless metropolitan area network (“WMAN”) such a WiMAX network, or a cellular network. Alternatively, the network(s) may be a wired network such as, but not limited to, a WAN such as the Internet, a LAN, a wired PAN, or a wired MAN.

Turning now to FIG. 7, additional details of an embodiment of a network 700 is illustrated, according to an illustrative embodiment. The network 700 includes a cellular network 702 (e.g., which can be or can include the mobile communications network 130), a packet data network 704, for example, the Internet 118, and a circuit switched network 706, for example, a publicly switched telephone network (“PSTN”). The cellular network 702 includes various components such as, but not limited to, base transceiver stations (“BTSs”), node-B's or e-node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, general packet radio service (“GPRS”) core network components, location service nodes, an IP multimedia subsystem (“IMS”), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the user devices 110, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSDPA), and HSPA+. The cellular network 702 also is compatible with 4G mobile communications standards as well as evolved and future mobile standards.

The packet data network 704 includes various devices, for example, servers, computers, databases, and other devices in communication with another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. In some embodiments, access to the packet data network 704 can be provided, at least in part, via WIFI, BLUETOOTH, BLUETOOTH LE, and/or other communications protocols.

The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a personal computer (“PC”), a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. In the specification, the network 700 may be used to refer broadly to any combination of the networks 702, 704, 706. It should be appreciated that substantially all of the functionality described with reference to the network 700 can be performed by the cellular network 702, the packet data network 704, and/or the circuit switched network 706, alone or in combination with other networks, network elements, and the like.

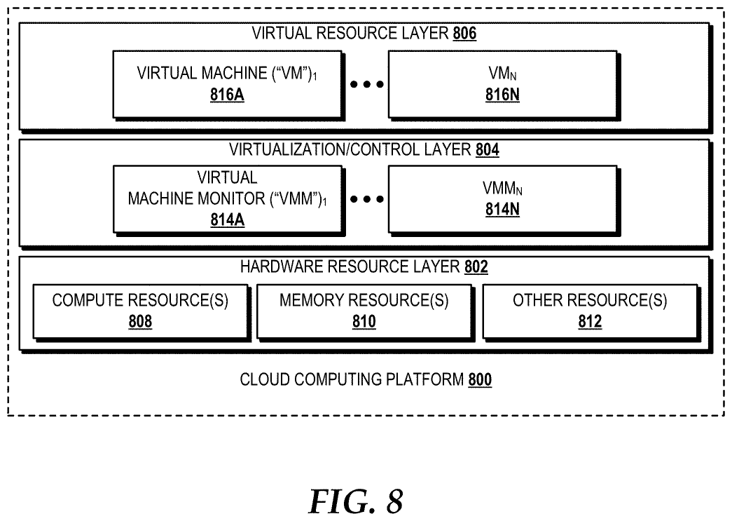

Turning now to FIG. 8, a cloud computing platform 800 will be described, according to an exemplary embodiment. The architecture of the cloud computing platform 800 can be used to implement, at least in part, the POS system 114, the local store network 116, the Internet 118, the local store database 120, the product competition assessment system 160, the mobile communications network 130, the online store network 131, the local store database 120, the online store database 133 and/or other systems, networks, devices, and/or facilities as virtual counterparts to physical systems, networks, devices, and/or facilities disclosed herein. The cloud computing platform 800 is a shared infrastructure that can support multiple services and network applications. The illustrated cloud computing platform 800 includes a hardware resource layer 802, a virtualization/control layer 804, and a virtual resource layer 806 that work together to perform operations as will be described in detail herein.

The hardware resource layer 802 provides hardware resources, which, in the illustrated embodiment, include one or more compute resources 808, one or more memory resources 810, and one or more other resources 812. The compute resource(s) 808 can include one or more hardware components that perform computations to process data, and/or to execute computer-executable instructions of one or more application programs, operating systems, and/or other software. The compute resources 808 can include one or more central processing units (“CPUs”) configured with one or more processing cores. The compute resources 808 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 808 can include one or more discrete GPUs. In some other embodiments, the compute resources 808 can include CPU and GPU components that are configured in accordance with a co-processing CPU/GPU computing model, wherein the sequential part of an application executes on the CPU and the computationally-intensive part is accelerated by the GPU. The compute resources 808 can include one or more system-on-chip (“SoC”) components along with one or more other components, including, for example, one or more of the memory resources 810, and/or one or more of the other resources 812. In some embodiments, the compute resources 808 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 808 can be or can include one or more hardware components architected in accordance with an ARM architecture, available for license from ARM HOLDINGS of Cambridge, United Kingdom. Alternatively, the compute resources 808 can be or can include one or more hardware components architected in accordance with an x86 architecture, such an architecture available from INTEL CORPORATION of Mountain View, Calif., and others. Those skilled in the art will appreciate the implementation of the compute resources 808 can utilize various computation architectures, and as such, the compute resources 808 should not be construed as being limited to any particular computation architecture or combination of computation architectures, including those explicitly disclosed herein.

The memory resource(s) 810 can include one or more hardware components that perform storage operations, including temporary or permanent storage operations. In some embodiments, the memory resource(s) 810 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 808.

The other resource(s) 812 can include any other hardware resources that can be utilized by the compute resources(s) 808 and/or the memory resource(s) 810 to perform operations described herein. The other resource(s) 812 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 814A-814N (also known as “hypervisors”; hereinafter “VMMs 814”) operating within the virtualization/control layer 804 to manage one or more virtual resources that reside in the virtual resource layer 806. The VMMs 814 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 808, the memory resources 810, the other resources 812, or any combination thereof. In the illustrated embodiment, the virtual resource layer 806 includes VMs 816A-816N (hereinafter “VMs 816”). Each of the VMs 816 can execute one or more software applications, such as, for example, software application including instructions to implement, at least in part, one or more components described herein.

Based on the foregoing, it should be appreciated that aspects of using location data and mobile application data to assess product competition have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
obtaining, by a product competition assessment system comprising a processor, temporal location data for a user device associated with a customer, wherein the temporal location data identifies a local store and a time period in which the customer was located at the local store;
obtaining, by the product competition assessment system, device usage data corresponding to the customer using the user device during the time period in which the customer was located at the local store;
obtaining, by the product competition assessment system, point-of-sale data from a point-of-sale system associated with the local store, wherein the point-of-sale data comprises a purchase history associated with the customer during the time period in which the customer was located at the local store; and
determining, by the product competition assessment system, whether the purchase history identifies an item also identified in the device usage data.

2. The method of claim 1, wherein:
in response to determining, by the product competition assessment system, that the purchase history does not identify the item also identified in the device usage data; and
notifying, by the product competition assessment system, the local store that the item was not purchased at the local store.

3. The method of claim 2, wherein obtaining, by the product competition assessment system, the device usage data comprises obtaining, by the product competition assessment system, the device usage data from an application executing on the user device.

4. The method of claim 3, wherein the application records an input to the user device provided by the customer.

5. The method of claim 4, wherein the application comprises a software application.

6. The method of claim 4, wherein the application comprises an operating system application.

7. The method of claim 4, wherein the application comprises is implemented in a firmware of the user device.

8. The method of claim 2, wherein the device usage data and the point-of-sale data are encrypted to obfuscate personally identifiable information associated with the customer.

9. The method of claim 8, further comprising:
decrypting, by the product competition assessment system, the device usage data and the point-of-sale data to match the customer to the purchase history without exposing the personally identifiable information associated with the customer.

10. A product competition assessment system comprising:
a processor; and
a memory that stores computer-executable instructions that, when executed by the processor, cause the processor to perform operations comprising
obtaining temporal location data for a user device associated with a customer, wherein the temporal location data identifies a local store and a time period in which the customer was located at the local store,
obtaining device usage data corresponding to the customer using the user device during the time period in which the customer was located at the local store,
obtaining point-of-sale data from a point-of-sale system associated with the local store, wherein the point-of-sale data comprises a purchase history associated with the customer during the time period in which the customer was located at the local store, and
determining whether the purchase history identifies an item also identified in the device usage data.

11. The product competition assessment system of claim 10, wherein the operations further comprise:
in response to determining that the purchase history does not identify the item also identified in the device usage data; and
notifying the local store that the item was not purchased at the local store.

12. The product competition assessment system of claim 11, wherein obtaining the device usage data comprises obtaining the device usage data from an application executing on the user device.

13. The product competition assessment system of claim 12, wherein obtaining the device usage data from the application executing on the user device comprises:
obtaining the device usage data from a software application;
obtaining the device usage data from a firmware of the user device; or
obtaining the device usage data from an operating system of the user device.

14. The product competition assessment system of claim 12, wherein the device usage data and the point-of-sale data are encrypted to obfuscate personally identifiable information associated with the customer.

15. The product competition assessment system of claim 14, further comprising decrypting the device usage data and the point-of-sale data to match the customer to the purchase history without exposing the personally identifiable information associated with the customer.

16. A computer-readable storage medium having computer-executable instructions that, when executed by a processor, cause the processor to perform operations comprising:
obtaining temporal location data for a user device associated with a customer, wherein the temporal location data identifies a local store and a time period in which the customer was located at the local store;
obtaining device usage data corresponding to the customer using the user device during the time period in which the customer was located at the local store;
obtaining point-of-sale data from a point-of-sale system associated with the local store, wherein the point-of-sale data comprises a purchase history associated with the customer during the time period in which the customer was located at the local store; and
determining whether the purchase history identifies an item also identified in the device usage data.

17. The computer-readable storage medium of claim 16, wherein the operations further comprise:
in response to determining that the purchase history does not identify the item also identified in the device usage data; and
notifying the local store that the item was not purchased at the local store.

18. The computer-readable storage medium of claim 17, wherein obtaining the device usage data comprises obtaining the device usage data from an application executing on the user device.

19. The computer-readable storage medium of claim 18, wherein the device usage data and the point-of-sale data are encrypted to obfuscate personally identifiable information associated with the customer.

20. The computer-readable storage medium of claim 19, wherein the operations further comprise decrypting the device usage data and the point-of-sale data to match the customer to the purchase history without exposing the personally identifiable information associated with the customer.
